(19) United States
(12) Patent Application Publication
(10) Pub. No.: US 2005/0205741 A1
(43) Pub. Date: Sep. 22, 2005

(54) Ceiling-attached multimedia player

(75) Inventor: Tonny Chen, Changhua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/805,269

(22) Filed: Mar. 22, 2004

(51) Int. Cl. H04N 5/46

(52) U.S. Cl. 248/317; 248/917

(57) ABSTRACT

A ceiling-attached multimedia player combines a display device and a flipping multimedia player in a base. The base is fastened to the inner side of the car top and houses the flipping multimedia player. The base also has a bottom edge pivotally coupled with the flipping display device which holds a display screen visible to rear seat passengers. The ceiling-attached multimedia player thus constructed is easy to install and operate.

### BACKGROUND OF THE INVENTION

1. Field of the Invention

The present invention relates to a ceiling-attached multimedia player and particularly to a ceiling-attached multimedia player that couples a display device and a flipping multimedia player on a base to facilitate installation and operation.

2. Description of the Prior Art

Nowadays equipping a multimedia player system in the car has become a growing trend. The system generally includes a multimedia player and a display screen installed on separated locations in the car. They are usually located at the front seat area of the car and close to each other to facilitate wiring and disk selection and operation. However, it is inconvenient for the rear seat passengers to see the programs. To remedy this problem, some vendors have introduced a ceiling-attached multimedia player (or called ceiling-attached optical disc player). It generally includes two types: one is the retrieval multimedia player such as the one disclosed in U.S. Pat. No. Des. 451895. Another type is the flattop multimedia player. The retrieval type is easier for loading and unloading the disk, but it has a complex mechanism and is more expensive. It also is bulky and not suitable to be installed on cars that have a lower car top. The flattop type is cheaper and thinner, but loading and unloading of the disk usually is done at a lower side of the device. Operation is inconvenient. Due to gravity and shaking of the car, the disk tends to drop easily during loading and unloading operations. As a result, the disk could be damaged. All this shows that there is still room for improvement.

### SUMMARY OF THE INVENTION

In view of the aforesaid disadvantages, the present invention aims to provide a ceiling-attached multimedia player that couples a display device and a flipping multimedia player on a base to facilitate installation and operation so that the rear seat passengers can see the programs conveniently. The flipping structure according to the invention adopts the flattop multimedia player to replace the retrieval multimedia player to save fabrication cost and overcome the drawbacks occurred to the conventional flattop multimedia player.

In order to achieve the foregoing object, the ceiling-attached multimedia player according to the invention includes a base fastened to the inner side of the car top. The base houses a flipping multimedia player. The base has a bottom edge pivotally coupled with a flipping display device. The display device has a display screen on an inner side visible to the rear seat passengers. By means of such a construction, the display device and the flipping multimedia player may be coupled on the base and be seen by the rear seat passengers. In other words, the invention employs a flipping structure to use the flattop multimedia player to substitute the retrieval multimedia player so that production cost may be greatly reduced to overcome the problems occurred to the conventional flattop multimedia players.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a perspective view of the invention with the display device flipping downwards.

FIG. 3 is a schematic view of the invention showing the top end.

FIG. 4 is a sectional view of the invention.

FIG. 5 is a cross section taken on line I-I in FIG. 1.

FIG. 6 is a schematic view of the invention showing the display device is flipping for folding.

FIG. 7 is a schematic view of the invention showing the flipping multimedia player is folding.

FIG. 8 is a cross section taken on line II-II in FIG. 3.

FIG. 9 is a perspective view of the invention showing the flipping multimedia player in a flipping condition.

### DESCRIPTION OF THE PREFERRED EMBODIMENT

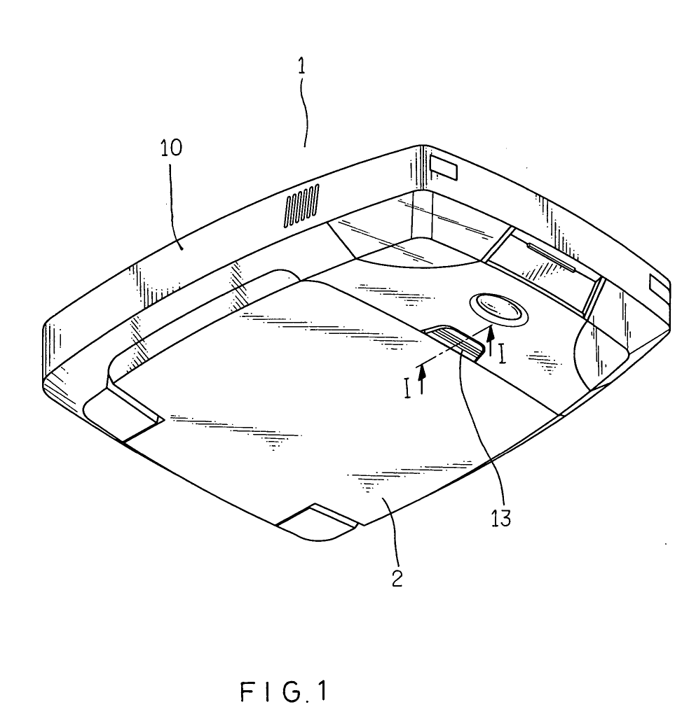

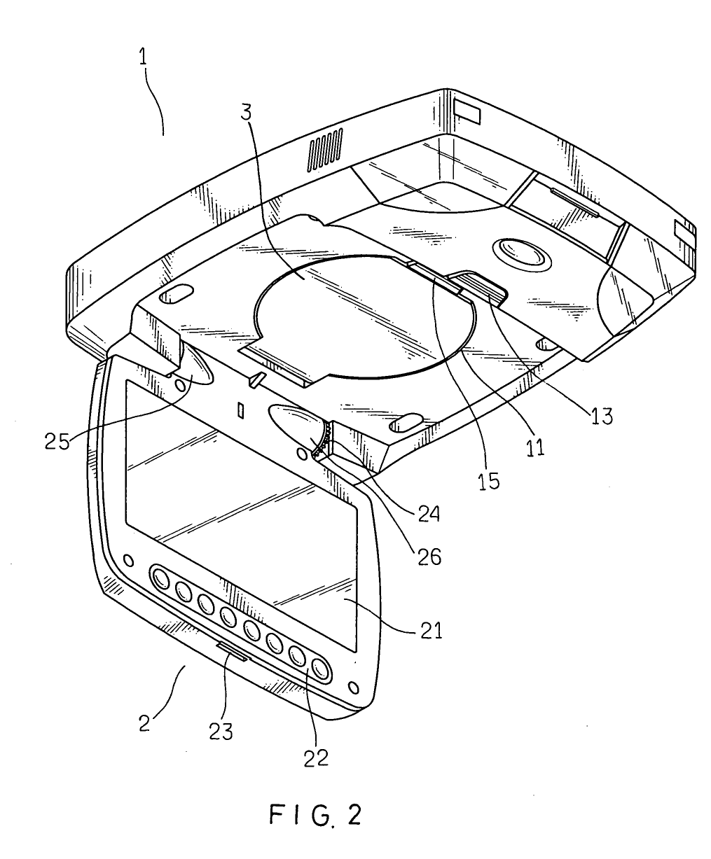

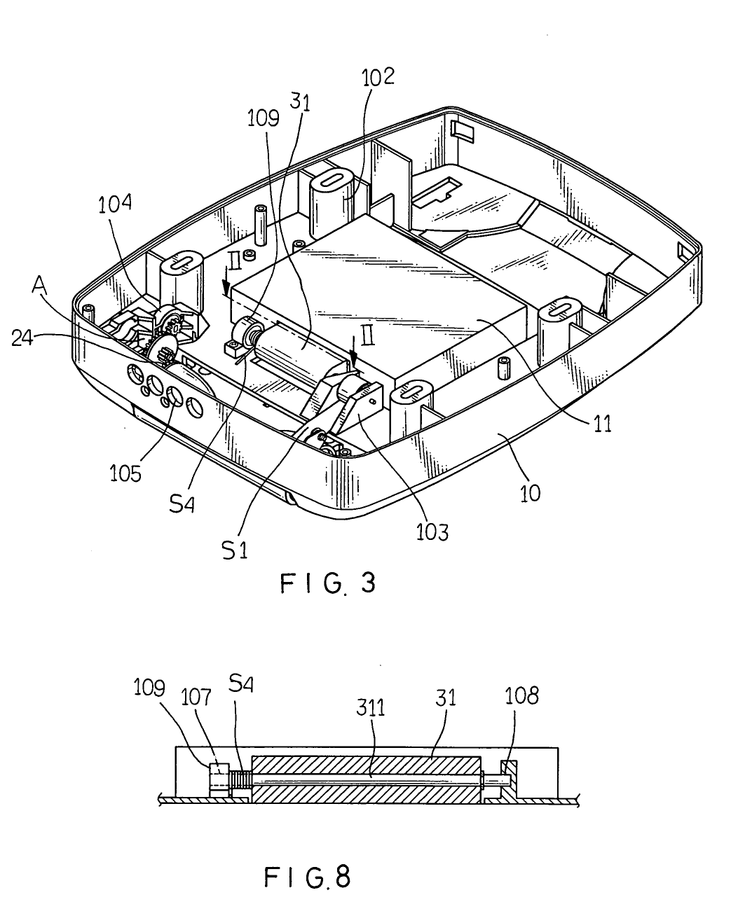

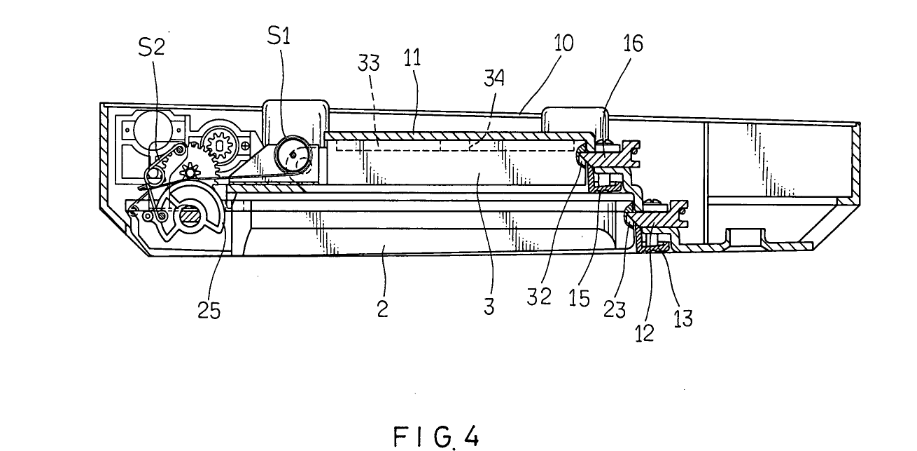

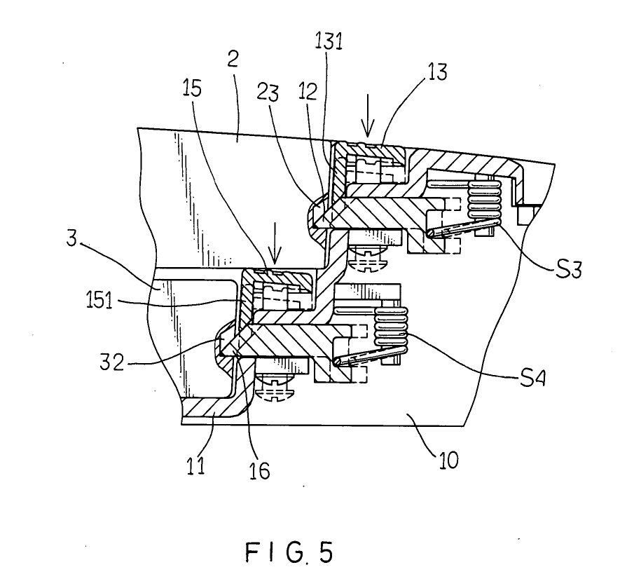

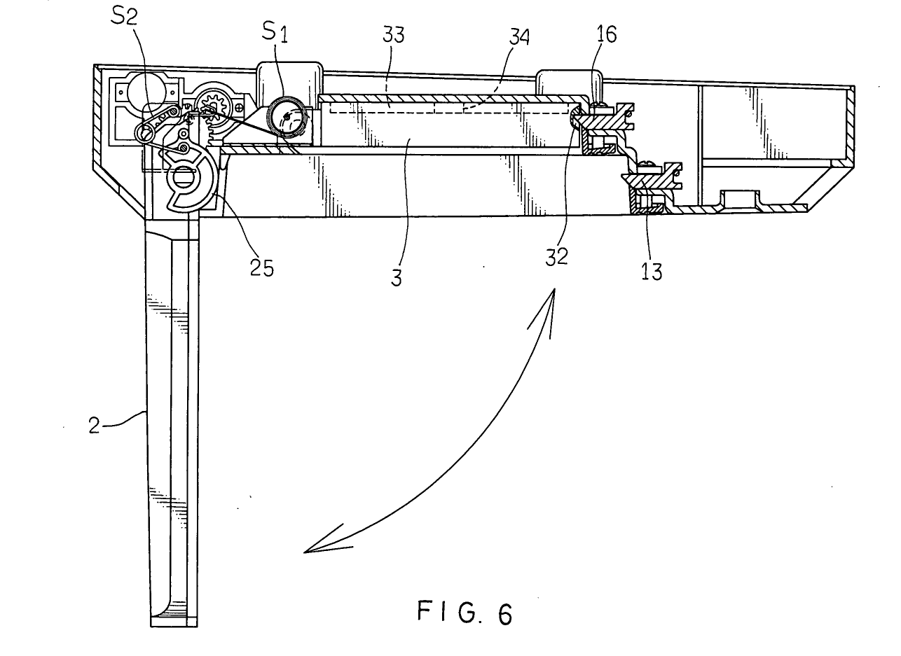

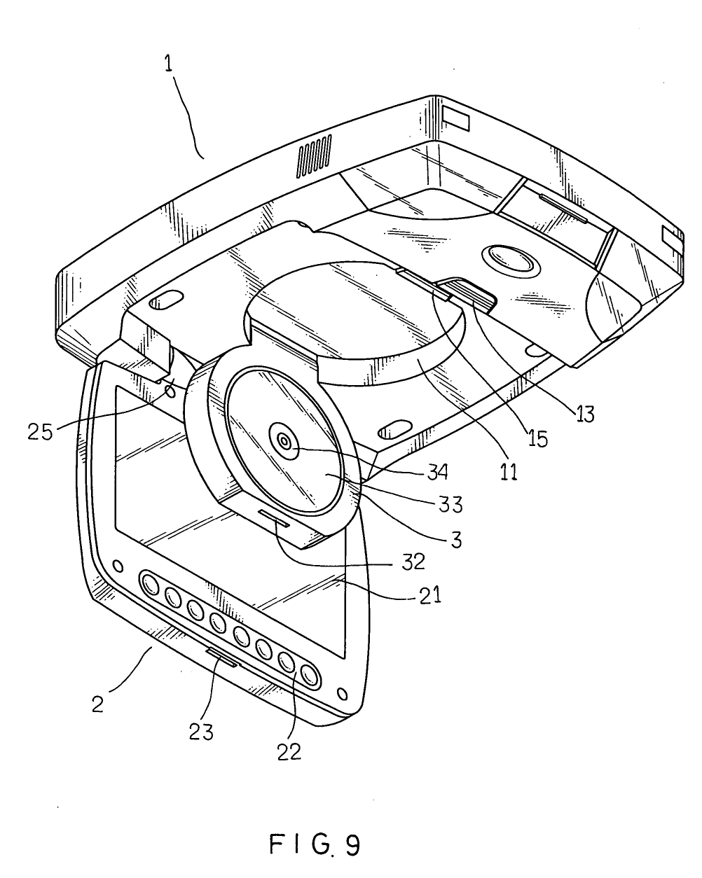

Referring to FIGS. 1, 2 and 3, the ceiling-attached multimedia player according to the invention includes a base 10 fastened to the inner side of a car top and a display device 2 pivotally coupled on the bottom edge of the base and may be flipped downwards. The display device 2 has a display screen 21 located on an inner side thereof visible to the rear seat passengers. The base 10 has an indented housing dock 11 (referring to FIGS. 3 and 4) on the top for housing a flipping multimedia player 3 (being a known flattop type multimedia player, such as a DVD player, VCD player, CD player, blue light DVD player, and the like). The display device 2 is connected to the multimedia player. The base 10 has a first bracing seat 103 on one side and a second bracing seat 104 on another side that correspond to each other to pivotally couple with a first pivot seat 25 and a second pivot seat 26 on the rear end of the flipping display device 2, and serve as the turning axle of the display device 2 for flipping. The first pivot seat 103 has two elastic elements S1 and S2 (referring to FIGS. 2, 3, 4 and 6) to provide elastic forces to flip and turn the display device 2. The second pivot seat 104 has a reducing gear set A to engage with an axle gear 24 located on one side of the display device 2 to serve as a buffer of the turning of the display device 2. The housing dock 11 has a first axle hole 107 on one side and a second axle hole 108 on another side that correspond to each other and couple with an axle 311 housed in an axle seat 31 at the rear end of the flipping multimedia player 3. The axle 311 has one end running through an elastic element S4 which provides an elastic force to keep the flipping multimedia player 3 unfolded in normal conditions (referring to FIGS. 3, 7, 8 and 9). The first axle hole 107 also houses a damper 109 which serves as a buffer to reduce the speed of turning. The flipping multimedia player 3 has a disk holding trough 33 and a turning shaft 34 in the center to hold a disk 35. The shaft 34 can turn the disk 35 for reading signals. The flipping multimedia player 3 further has a second latch trough 32 on the front edge to couple with a second latch tongue 16 of the base 10, and is controlled by a second button 15 (referring to FIG. 5) to control closing and anchoring of the flipping multimedia player 3. There are a plurality of fastening struts 102 located on the peripheral side of the housing dock 11 to receive bolts (not shown in the drawings) to fasten the ceiling-attached multimedia player 1 to the inner side of the car top. The base 10 further has at least one video input end 105 on a lateral side to couple with an external video display device such as X-BOX or PS to broadcast video information. There is also a video output end (not shown in the drawings) to facilitate delivery of video signals to other devices.

Aside from having the display screen 21 on the inner side of the display device 2 (referring to FIG. 2), there is a button key set 22 on the periphery of the display device. The display device 2 further has a first latch trough 23 on the front edge to couple with a first latch tongue 12, and is controlled by the first button 13 (referring to FIG. 5) to control closing and anchoring of the display device 2.

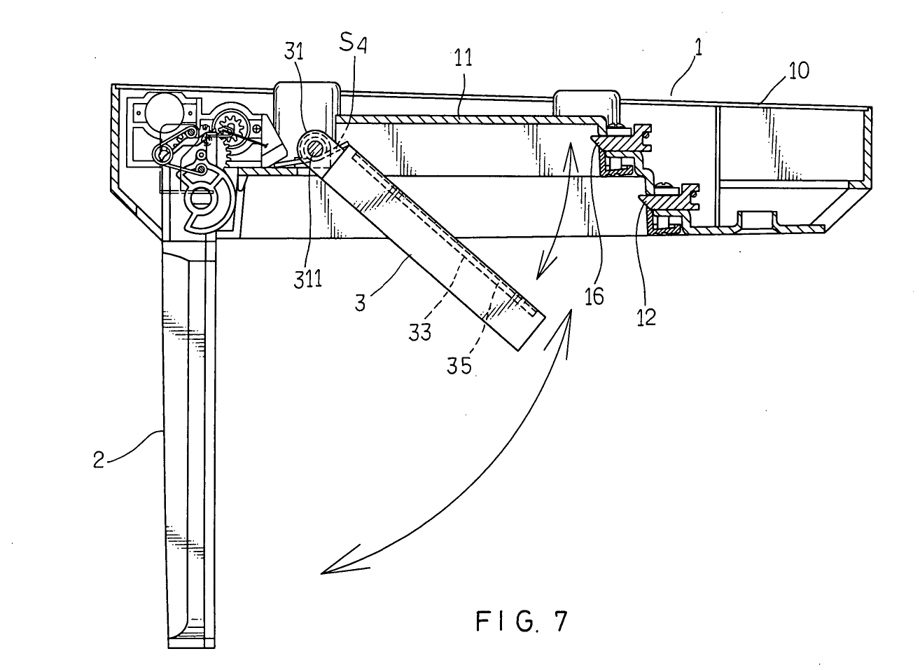

When the passengers on the rear seat want to see the video programs, they depress the first button 13 to move a slant rib 131 on one edge to retract the first latch tongue 12 and release the latch condition. The display device 2 is urged by the returning elastic force of the elastic elements S1 and S2 and turns to a desired position (referring to FIGS. 2, 5 and 6). Then users may depress the button key set 22 to turn on power supply, and depress the second button 15 to move another slant rib 151 to retract the second latch tongue 16 to release the latch condition so that the flipping multimedia player 3 may be urged by the returning elastic force of the elastic element S4 and flipped out (referring to FIG. 7). Then the disk 35 may be placed in the disk holding trough 33, and the flipping multimedia player 3 may be moved upwards for closing. The second latch tongue 16 is coupled with the second latch trough 32 again. (operation of the disk playing is same as the conventional players, details are omitted). A radio emission circuit (not shown in the drawings) may be added to receive and broadcast audio signals so that users can hear the audio signals through radio ear phones.

To close the ceiling-attached multimedia player 1, proceed the foregoing operations reverse to retrieve the disk, and move the flipping multimedia player 3 and the display device 2 upwards for folding (as the first latch tongue 12 is extended by the elastic element S3 in normal conditions, when the display device 2 is folded, it is latched in the first latch trough 23 to anchor the display device 2).

In summary, the invention combines the display device and the flipping multimedia player on the same base to facilitate operations. And people sitting on the rear seat can directly select the disks and operate easily. Installation is simple, and cost is lower. It is a significant improvement over the conventional flattop multimedia players.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

1. A ceiling-attached multimedia player, comprising:
a base fastened to an inner side of a car top having a bottom edge pivotally coupled with a flipping display device and a housing dock for holding a flipping multimedia player; wherein:
the display device has a display screen on an inner side visible to rear seat passengers of a car; and
the flipping multimedia player is a flattop multimedia player connecting to the display device for playing multimedia programs.

2. The ceiling-attached multimedia player of claim 1, wherein the flipping multimedia player is a DVD player.

3. The ceiling-attached multimedia player of claim 1, wherein the flipping multimedia player is a VCD player.

4. The ceiling-attached multimedia player of claim 1, wherein the flipping multimedia player is a CD player.

5. The ceiling-attached multimedia player of claim 1, wherein the flipping multimedia player is a blue light DVD player.

6. The ceiling-attached multimedia player of claim 1 further having a video input end to allow an external video player to broadcast video/audio information.

7. The ceiling-attached multimedia player of claim 1 further having a video output end to connect an external video player to output video/audio information.
